(19) United States
(12) Patent Application Publication
(10) Pub. No.: US 2005/0009523 A1
(43) Pub. Date: Jan. 13, 2005

(54) Protocol using forward error correction to improve handover

(75) Inventor: Harri Pekonen, Raisio (FI)

Correspondence Address: BANNER & WITCOFF, 1001 G STREET N W, SUITE 1100, WASHINGTON, DC, 20001, US

(73) Assignee: Nokia Corporation, ESPOO (FI)

(21) Appl. No.: 10/614,313

(22) Filed: Jul. 7, 2003

(51) Int. Cl. H04Q 7/20

(52) U.S. Cl. 455/436; 455/438

(57) ABSTRACT

The present invention provides methods and apparatus for a wireless system broadcasting a plurality of data packets to a wireless terminal as the wireless terminal performs a handover in order to support a service. Corresponding data packets are sent in bursts from base stations to the wireless terminal. The data packets are encoded with a forward error correcting (FEC) code, thus generating encoded symbols. When the wireless terminal executes a handover from the first base station to the second base station, some of the encoded symbols (that are contained in the bursts of data packets) may be lost or may be corrupted, as result of practical network considerations and radio propagation characteristics. Consequently, the wireless terminal decodes the received data packets in accordance with the FEC code so that missing or corrupted encoded symbols may be determined.

### FIELD OF THE INVENTION

This invention relates to burst transmission of audio data, video data, control data, or other information and, in particular, to apparatus and method for providing interrupt-free handover in a wireless terminal.

### BACKGROUND OF THE INVENTION

Video streaming, data streaming, and broadband digital broadcast programming are increasing in popularity in wireless network applications, e.g. Internet protocol (IP) multicast services. To support these wireless applications, wireless broadcast systems transmit data content that support data services to many wireless terminals simultaneously. A wireless broadcast system typically comprises a plurality of base stations, in which data content is distributed by a service source through a backbone network. Wireless broadcast systems are typically unidirectional networks, in which there may not be an uplink channel (i.e. wireless terminal to serving base station) available. Thus, a wireless terminal may not be able to request lost data packets that are associated with a data service from the wireless broadcast system. When the wireless broadcast system has more than one base station serving different transmitting coverage areas (also known as cells), the base stations should transmit data services so that a wireless terminal is able to receive associated data packets in a seamless fashion as the wireless terminal moves from a coverage area of one base station to another coverage area of another base station. Seamlessness entails that the wireless terminal receive all data packets as the wireless terminal performs a handover from one base station to another. However, data packets, as distributed by a backbone network, may not arrive to all the base stations of a wireless broadcast system at the same time and in the same order, resulting from variable time delays within the backbone network. Typically, a base station, as with multicast broadcast services using a user datagram protocol (UDP), does not order data packet numbering. Moreover, a radio path between a serving base station and a wireless terminal may experience signal fading, resulting in imperfect reception at the wireless terminal. Consequently, as a wireless terminal moves among cells, information signals may be lost or corrupted, especially when a handover occurs.

What is needed are systems and methods for providing an interrupt-free information and data flow to a wireless terminal receiving data and information from multiple wireless base stations.

### BRIEF SUMMARY OF THE INVENTION

An aspect of the present invention provides methods and apparatus for a wireless system broadcasting a plurality of data packets to at least one wireless terminal as the wireless terminal performs a handover. The wireless system comprises a plurality of base stations that interface to a backbone network in order to receive the plurality of data packets from a service source in order to support a service. Data packets are sent to a wireless terminal by a first base station transmitting a first burst of data packets and by a second base station transmitting a second burst of data packets. The data packets are encoded with a forward error correcting (FEC) code, thus generating encoded symbols. When the wireless terminal executes a handover from the first base station to the second base station, some of the encoded symbols (that are contained in the bursts of data packets) may be lost or may be corrupted, as result of practical network considerations and radio propagation characteristics. Consequently, the wireless terminal decodes the received data packets in accordance with the FEC code so that missing or corrupted encoded symbols may be determined. The FEC code is typically selected so that a possible number of missing or corrupted encoded symbols can be corrected in accordance with the selected FEC code.

In an embodiment of the invention, the FEC code comprises a block FEC code with N encoded symbols having K information encoded symbols. A data object, which may be a file or a portion of a streaming data, is represented by the K information encoded symbols. A data packet in a burst contains at least one encoded symbol. A wireless terminal is able to recover the K information encoded symbols by receiving a subset of the N encoded symbols. With a variation of the embodiment, a transmitted data object may be encoded with an expanded FEC code.

### BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 shows a multicast backboned broadcast network that interconnects a service source to base stations in order to deliver data services in accordance with an embodiment of the invention;

FIG. 2 shows transmission of Internet Protocol (IP) services utilizing time slice transmission in accordance with an embodiment of the invention;

FIG. 3 shows a wireless system with two transmission center frequency values in accordance with an embodiment of the invention;

FIG. 4 shows a wireless system with three transmission center frequency values in accordance with an embodiment of the invention;

FIG. 5 shows a wireless system that utilizes time slice transmission for a scenario corresponding to a nominal situation in accordance with an embodiment of the invention;

FIG. 6 shows a wireless system that utilizes time slice transmission in which an associated backbone network is characterized by a time delay in accordance with an embodiment of the invention;

FIG. 7 shows a wireless system that utilizes time slice transmission in which an associated backbone network is characterized by data packet reordering in accordance with an embodiment of the invention;

FIG. 8 shows encoding a transmitted data object in accordance with an embodiment of the invention;

FIG. 9 shows an architecture of a telecommunications system for encoding and decoding a data object in accordance with an embodiment of the invention;

FIG. 10 shows a flow diagram for decoding a received data object in accordance with an embodiment of the invention;

FIG. 11 shows apparatus for a base station that supports time slice transmission according to an embodiment of the invention;

FIG. 12 shows apparatus for a wireless terminal that supports time slice transmission according to an embodiment of the invention;

FIG. 13 shows apparatus for a service source that supports time slice transmission according to an embodiment of the invention;

FIG. 14 shows a flow diagram for a wireless terminal for determining if a handover is required in accordance with an embodiment of the invention; and

FIG. 15 shows a continuation of the flow diagram in FIG. 14.

### DETAILED DESCRIPTION OF THE INVENTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

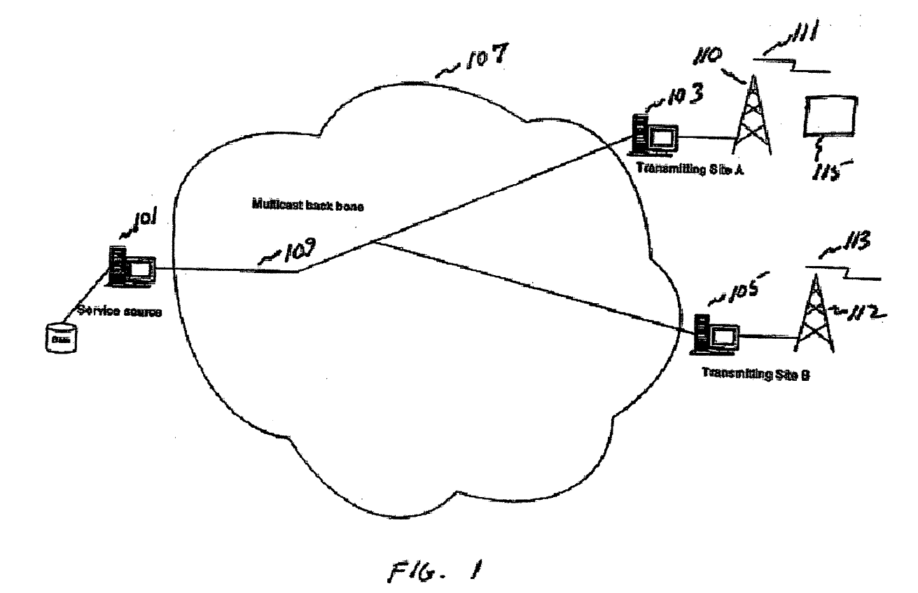

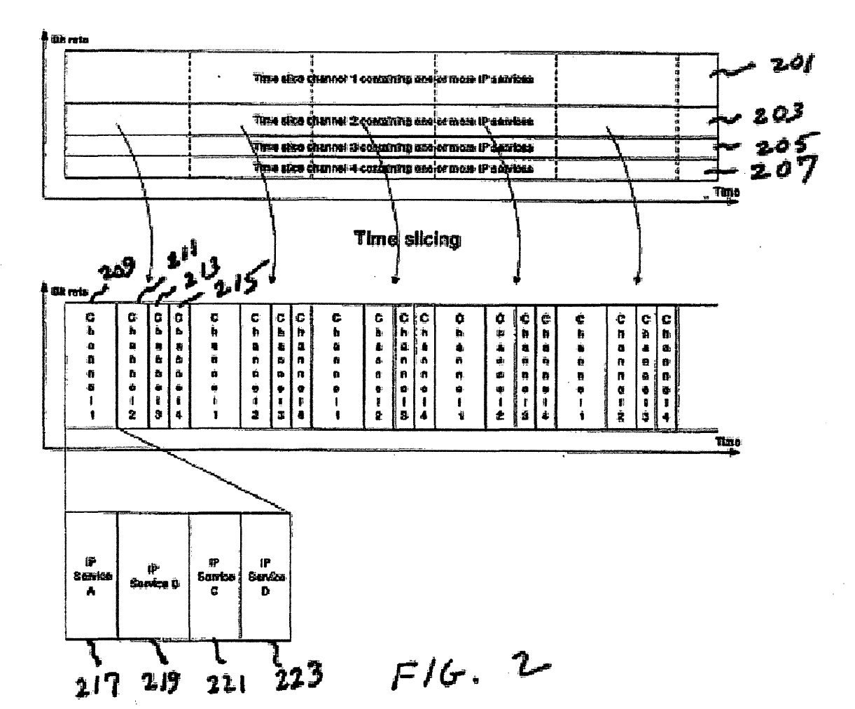

FIG. 1 shows a multicast backboned broadcast network 107 that interconnects a service source 101 to base stations 103 and 105 to deliver data services to a wireless terminal 115 in accordance with an embodiment of the invention. Data packets, corresponding to a data service, are transmitted by base stations 103 and 105 to wireless terminal 115 through antennas 110 and 112 over radio channels 111 and 113, respectively. Base stations 103 and 105 transmit data packets utilizing time slice transmission as discussed in the context of FIG. 2. Even though wireless terminal 115 is processing only one of the radio channels (either channel 111 or 113), both base stations 103 and 105 broadcast the same data packets.

FIG. 2 shows transmission of Internet Protocol (IP) services utilizing time slice transmission in accordance with an embodiment of the invention. A base station (e.g. base station 103) broadcasts data packets for a plurality of IP services using data streams 201, 203, 205, and 207. (Each data stream is allocated a portion of a data rate capacity.) In the embodiment, base station 103 may support functionality that is typically assumed by a base transceiver station (BTS), a base station controller (BSC), a combination of a BTS and a BSC, and a node B, which is a third Generation (3G) designation of a base transceiver station. Data transmission is essentially continuous such that data packets for an IP service are continuously being conveyed through a data stream.

In order to mitigate the loss of data packets, data streams 201, 203, 205, and 207 are mapped by base stations 103 and 105 into bursts of data packets 209, 211, 213, and 215, respectively, in which bursts are transmitted over radio channels 111 and 113 rather than data streams 201, 203, 205, and 207. Each data stream (201, 203, 205, and 207), and consequently each burst (209, 211, 213, and 215), supports at least one data service. Thus, each burst may support a plurality of data services (e.g. a group of related data services).

Data rates associated with bursts 209, 211, 213, and 215 are typically greater than data rates that are associated with data streams 201, 203, 205, and 207 so that a corresponding number of data packets can be sent in a shorter amount of time. In the embodiment, data streams 201, 203, 205, and 207 correspond to continuous data rates of approximately 100 Kbit/sec. Bursts 209, 211, 213, and 215 correspond to approximately 4 Mbit /sec with an approximate one second duration. However, other embodiments may use different data rates for data streams 201-207 and for bursts 209-215.

Wireless terminal 115 may be required to transfer to another base station (e.g. base station 105) while data packets are being transmitted. Because a certain amount of time is required for wireless terminal 115 to complete the handover process (e.g. tuning to a new center frequency), wireless terminal 115 may miss some of the data packets if bursts 209, 211, 213, and 215 were transmitted to wireless terminal 115 during the handover, causing a gap in reception. Depending upon the type of data service, a user of wireless terminal 115 may perceive the loss of data packets.

In the embodiment, the entire data rate capacity is allocated to a burst at a given time. As shown in FIG. 2, bursts 209, 211, 213, and 215 are interleaved in time. An idle time duration (during which data packets are not transmitted for the particular data service) occurs between consecutive transmissions of a burst (e.g. burst 209). A wireless broadcast system can utilize the idle time duration during which wireless terminal 115 can be instructed to transfer to another base station to complete a handover. The other base station (e.g. base station 105) may transmit the same data as the base station (e.g. base station 101) previously serving wireless terminal 115 using a different center frequency and a different amount of phase shift.

Bursts are typically transmitted periodically by a base station. For example, a subsequent burst may occur T seconds after burst 209, in which a burst is transmitted every T seconds. Wireless terminal 115 may maintain precise timing, as with the Global Positioning System (GPS), to determine an absolute time at which each burst occurs. In another embodiment, wireless terminal 115 is provided information about a time period in each burst, informing wireless terminal 115 about the subsequent burst. The time period may be included in an IP packet, a multiprotocol encapsulated frame, any other packet frame, and a third generation (3G) or General Packet Radio Service (GPRS) channel or modulation data, such as transmitter parameter signaling. Alternatively, wireless terminal 115 may detect an occurrence of a burst by receiving a signal preamble, which may be a data sequence that is known a priori to wireless terminal 115. In another embodiment, wireless terminal 115 may receive an overhead message on an overhead channel from a base station. The overhead message may contain timing information regarding the occurrence of bursts. The overhead channel may be logically or physically distinct from the downlink radio channel that supports the transmission of bursts.

Bursts 209, 211, 213, and 215 may be formatted by using a multi-protocol encapsulation in accordance with Section 7 of European Standard EN 301 192 “Digital Video Broadcasting (DVB), DVB specification for data broadcasting.” The encapsulation may conform to Internet Protocol (IP) standards.

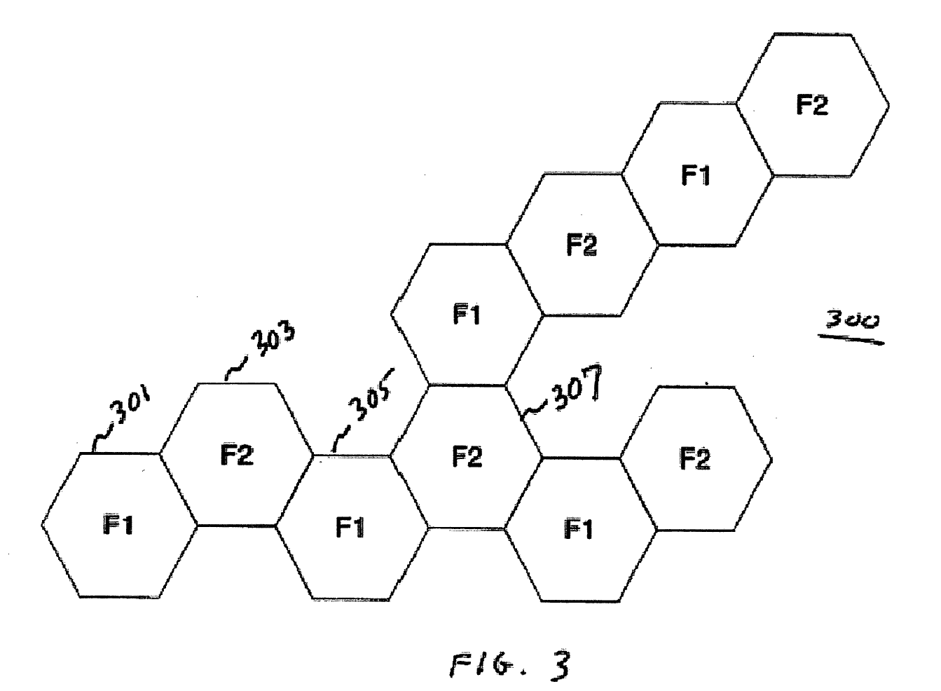

FIG. 3 shows a wireless system 300 with two transmission center frequency designations in accordance with an embodiment of the invention. A base station corresponding to a cell (e.g. cells 301, 303, 305, and 307) is assigned one of two different center frequency values F1 and F2. (A center frequency value corresponds to a center frequency of a frequency spectrum that is utilized by a base station.) Assigning different center frequency values to adjacent cells reduces interference from non-serving cells on wireless terminal 115. For example, when wireless terminal 115 traverses from cell 301 (corresponding to base station 103) to cell 303 (corresponding to base station 105), wireless terminal 115 retunes from center frequency value F1 to center frequency value F2. While wireless terminal 115 is being served within cell 301 or cell 303, wireless terminal 115 receives data packets contained in bursts that are transmitted by base station 103 or base station 105, respectively. With a configuration of only two center frequency values, as shown in FIG. 3, a topological configuration of the wireless system is restricted to “row-like” configurations.

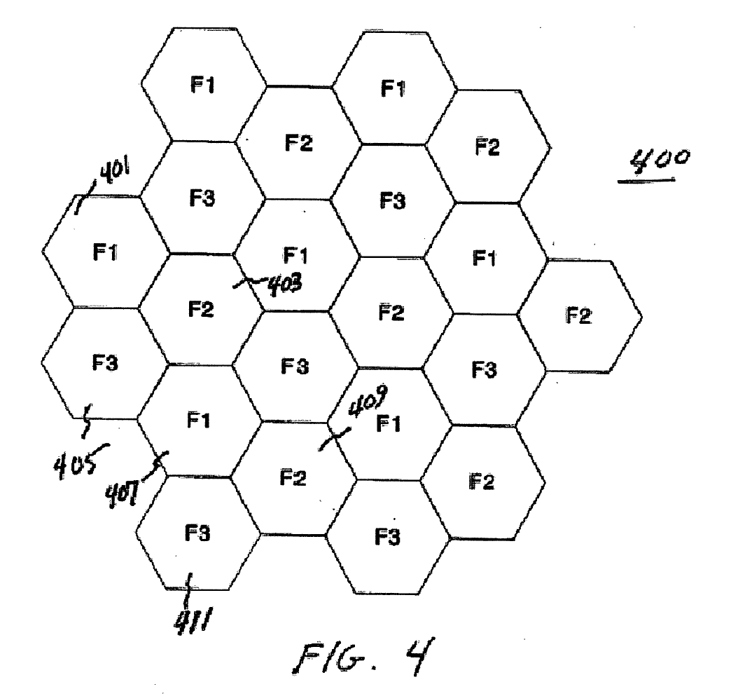

FIG. 4 shows a wireless system 400 with three transmission center frequency values in accordance with an embodiment of the invention. A base station corresponding to a cell (e.g. cells 401, 403, 405, 407, 409, or 411) is assigned one of three different center frequency values F1, F2, and F3. Wireless terminal 115 receives data packets through bursts that are transmitted by a base station corresponding to a cell in which wireless terminal 115 is located. With three center frequency values, a wireless system can assume a more complicated topological configuration than if only two center frequency values were assigned. However, as the number of center frequency values that are assigned to the wireless system increases, a required frequency spectrum for a wireless system increases.

Transmission configurations of wireless systems 300 and 400 are typically asymmetric in that a data rate from wireless system 300 or 400 to wireless terminal 115 (downlink or forward radio channel) is typically greater than a data rate from wireless terminal 115 to wireless system 300 or 400 (uplink or reverse radio channel).

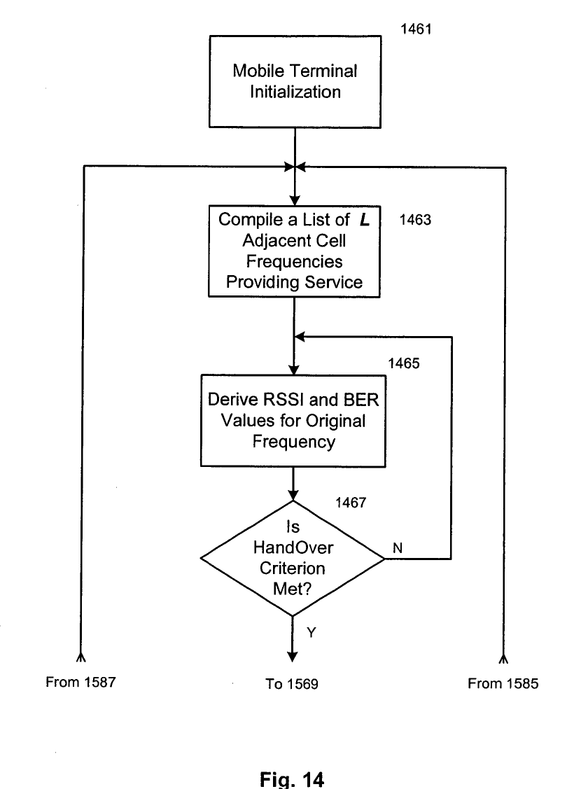

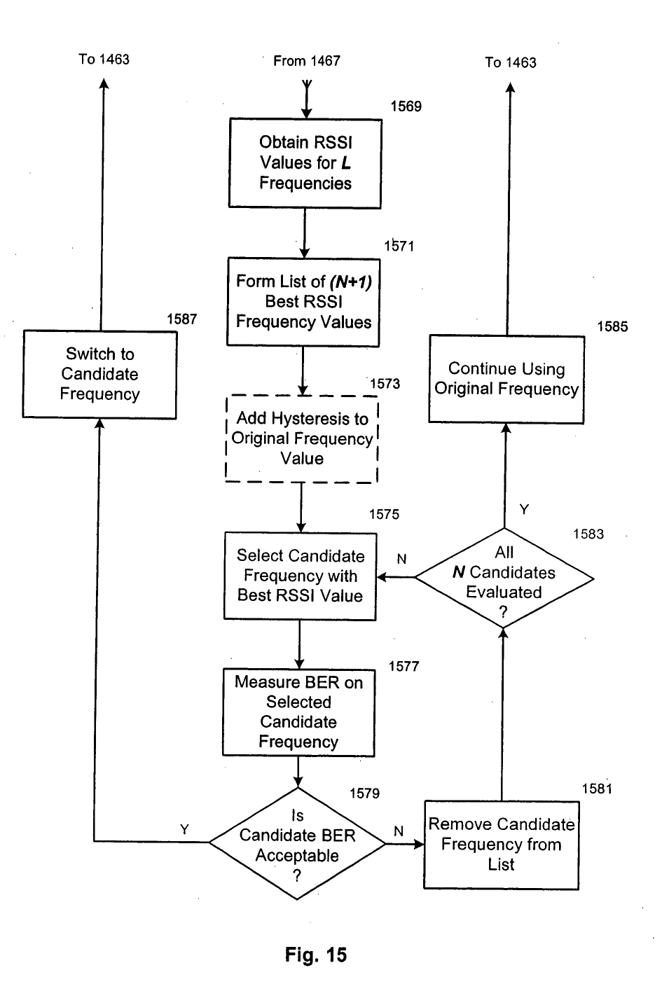

As will be discussed in the context of FIGS. 14 and 15, wireless system 300 or 400 may receive measured signal characteristics (e.g. signal strength, packet error rate, and bit error rate) from wireless terminal 115 over the uplink radio channel. Using the signal characteristics, wireless system 300 or 400 may instruct wireless terminal 115 to perform a handover from one base station to another base station as wireless terminal 115 traverses the corresponding cells. In other embodiments, wireless terminal 115 may perform a handover in accordance with the measured signal characteristics without being instructed by wireless system 300 or 400. In some embodiments, wireless system 300 or 400 may not support the uplink channel so that wireless terminal 115 does not send messaging to wireless system 300 or 400.

In the embodiments shown in FIGS. 3 and 4, cells (e.g. cells 301-307 and 401-411) are assigned center frequency values from a set of center frequency values that are associated with wireless system 300 and 400. Assigning different center frequency values to adjacent cells enables wireless terminal 115 to distinguish a signal transmitted from the base station (e.g. 103 or 105), corresponding to the cell in which wireless terminal 115 is located, from signals transmitted from other base stations. Such an assignment approach is referred to as frequency division multiple access (FDMA). However, other embodiments may provide orthogonal separation by alternative approaches such as channelization codes (e.g. Walsh codes) that are utilized with spread spectrum techniques, e.g., code division multiple access (CDMA). In such a case, a wideband signal is centered about a single frequency that is assigned to all the cells of a wireless system, in which each corresponding base station uses the same frequency spectrum. Adjacent cells are assigned different channelization codes in order to reduce interference from non-serving base stations upon wireless terminal 115. Wireless terminal 115 may process a received signal with an appropriate channelization code that is assigned to the serving base station.

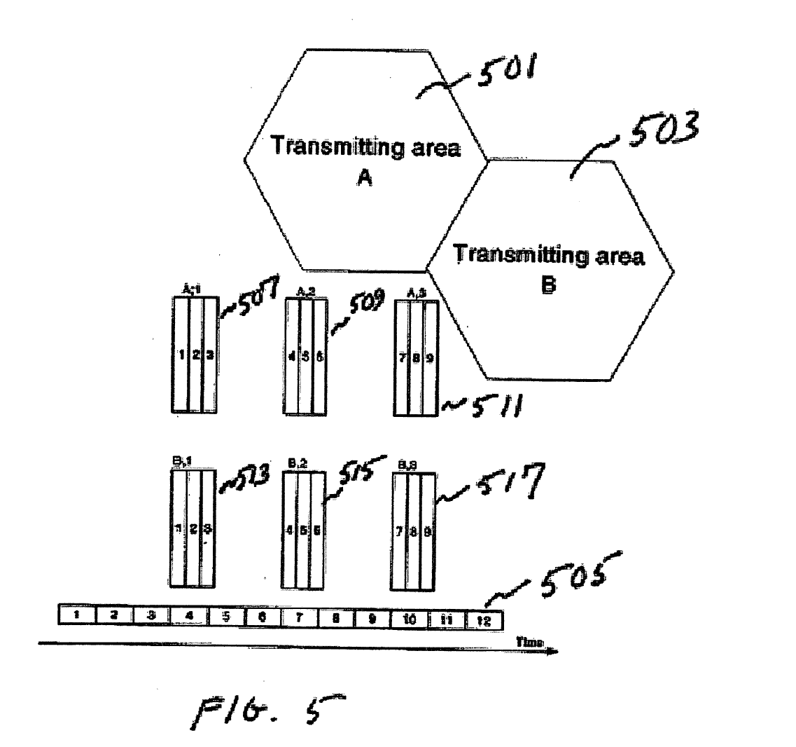

FIG. 5 shows a wireless system that utilizes time slice transmission for a scenario corresponding to a nominal situation in accordance with an embodiment of the invention. Bursts from cell 501 are synchronized with bursts from cell 503 (e.g. burst 507 occurs at essentially the same time as burst 513 and burst 509 occurs at essentially the same time as burst 515). The corresponding base stations that serve cells 501 and 503 are provided packet stream 505 through backbone network 107 such that packet delivery is synchronous. In this scenario, as shown in FIG. 5, wireless terminal 115 will receive all packets if wireless terminal 115 is handed over from cell 501 to 503. For example, if wireless terminal 115 receives burst 507 and burst 515 (as result of a handover from cell 501 to cell 503), wireless terminal 115 receives packet numbers 1, 2, 3, 4, 5, and 6, where a handover occurs between bursts. In FIG. 5, wireless terminal 115 receives packet numbers 1, 2 and 3 before the handover and receives packets numbers 4, 5, and 6 after the handover.

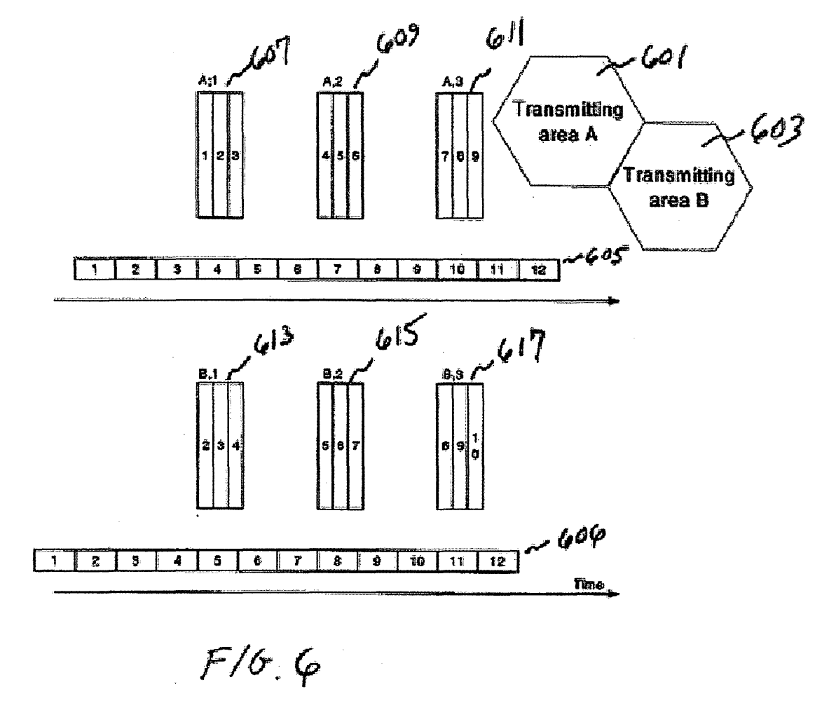

FIG. 6 shows a wireless system that utilizes time slice transmission in which associated backbone network 107 is characterized by a time delay (skewing). Bursts from cell 601 are synchronized with bursts from cell 603 (e.g. burst 607 occurs at essentially the same time as burst 613 and burst 609 occurs at essentially the same time as burst 615). With this scenario, base stations corresponding to cells 601 and 603 are provided packet streams 605 and 606, respectively, in which packet delivery times to the corresponding base stations are skewed with respect to each other, i.e. packets that are delivered to cell 601 are phased relative to packets that are delivered to cell 603. In this scenario, as shown in FIG. 6, wireless terminal 115 may not receive all data packets if wireless terminal 115 is handed over from cell 601 to 603. For example, if wireless terminal 115 receives burst 607 and burst 615 (as result of a handover from cell 601 to cell 603), wireless terminal 115 receives packet numbers 1, 2, 3, 5, 6, 7. In other words, wireless terminal 115 loses packet number 4.

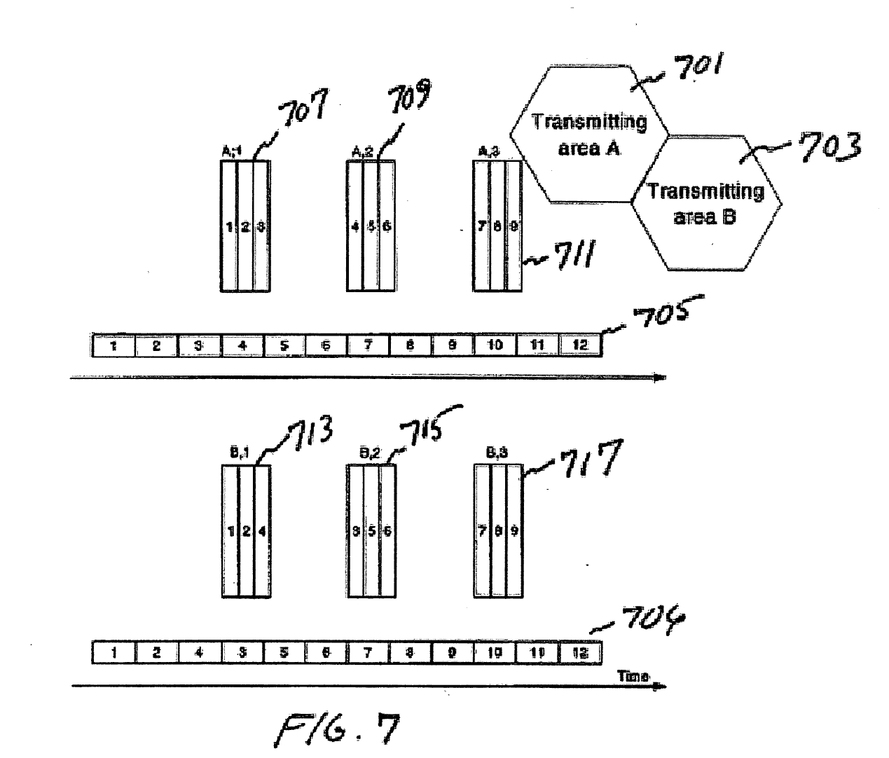

FIG. 7 shows a wireless system that utilizes time slice transmission in which backbone network 107 is characterized by data packet reordering. Bursts from cell 701 are synchronized with bursts from cell 703 (e.g. burst 707 occurs at essentially the same time as burst 713 and burst 709 occurs at essentially the same time as burst 715). With this scenario, base stations corresponding to cells 701 and 703 are provided packet streams 705 and 706, respectively, in which packet delivery times to the corresponding base stations are skewed with respect to each other. In this scenario, as shown in FIG. 7, wireless terminal 115 may not receive all packets if wireless terminal 115 is handed over from cell 701 to 703. For example, if wireless terminal 115 receives burst 707 and burst 715 (as result of a handover from cell 701 to cell 703), wireless terminal 115 receives packet numbers 1, 2, 3, 3, 5, and 6. In other words, wireless terminal 115 loses. packet number 4 and receives packet number 3 twice.

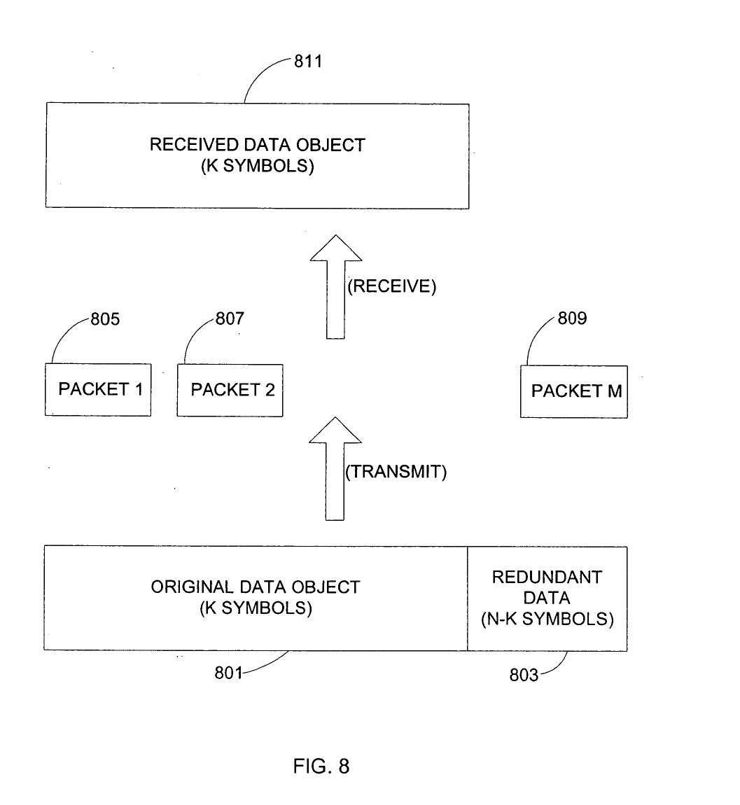

FIG. 8 shows encoding a transmitted data object 801 in accordance with an embodiment of the invention. Transmitted data object 801 may correspond to a data entity, e.g. a file, a portion of a file, a video frame, or a portion of a video frame. Data object 801 may be represented with K information symbols, where a block forward error correction (FEC) coder generates a total of N symbols by determining N-K redundant symbols (represented as redundant symbols 803). (Other embodiments of the invention may support other error correction codes.) The resulting N symbols are converted into M packets comprising packets 805-809. In the embodiment, the M packets are sent to wireless terminal 115 through serving base station 103 and 105 from service source 101 through multicast backbone network 107. Base stations 103 and 105 send the M data packets in at least one burst of packets. Wireless terminal 115 receives the N symbols and recovers received data object 811 (comprising K information symbols) from the received N symbols.

In selecting the FEC code, an operator of a wireless system may consider the nature of the service, in which different services may tolerate different error levels. Some services may be very sensitive to errors such as a scheduled download. Other services, such as a multicast streaming transmission, may tolerate substantially more errors. Also, time skewing and packet reordering on backbone network 107 may vary so that the potential loss of packets during a handover may occur. Additionally, an operator of a wireless system may engineer the wireless system to have an expected error rate and a corresponding packet error rate. Such considerations may affect the selection of the FEC code. Typically, the greater the number of packets (and the corresponding encoded symbols) that are lost or in error, the greater the number of redundant symbols (corresponding to N-K symbols) that are required for a desired degree of data transmission robustness. The FEC code typically is selected so that the FEC code has a capability of correcting errors that are associated with a handover.

With a variation of the embodiment, transmitted data object may be encoded with an expanded FEC code. An expandable FEC encoder takes K source symbols as input and generates as many unique encoding symbols as are requested on demand, where the amount of time for generating each encoding symbol is the same, independent of the number of encoding symbols that are generated. An expandable FEC decoder has a property that any K of the unique encoding symbols is sufficient to reconstruct the original K source symbols. With a variation of an expandable FEC encoder, slightly more than K encoding symbols are needed to recover the K source symbols. If K*(1+X) encoding symbols are needed, one may refer to a reception overhead as being X*100%. For example, if K*1.05 encoding symbols are needed, then the corresponding reception overhead is 5%.

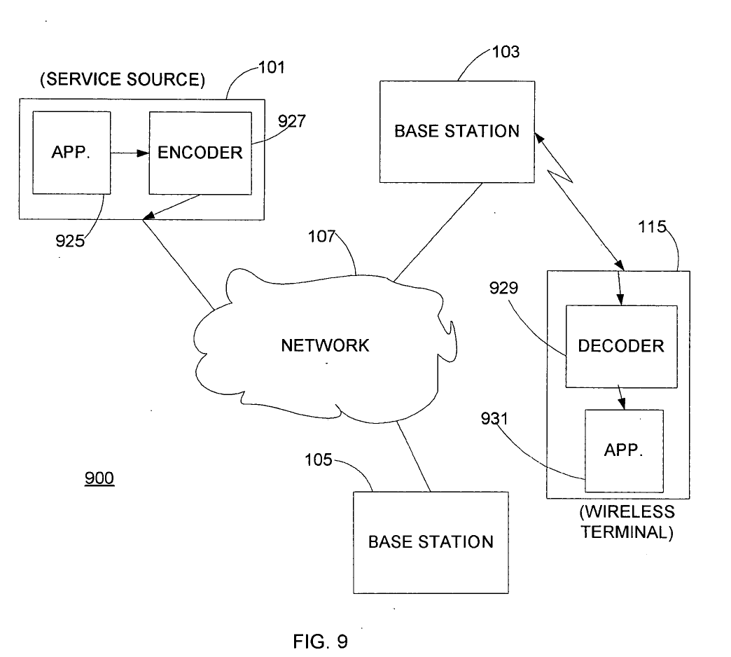

FIG. 9 shows an architecture of a wireless telecommunications system 900 for encoding and decoding a data object (e.g. data object 801 as shown in FIG. 8) in accordance with an embodiment of the invention. Telecommunications system 900, which provides a service for wireless terminal 115, comprises service source 101, backbone network 107, base station 103, and base station 105. In the embodiment, an encoder 927 (which is associated with service source 101 and which may be implemented with software that is executed by a processor or with hardware) encodes service data from application module 925 in accordance with the selected FEC code. Typically, service source 101 encodes the service data at a higher layer. The embodiment may support a layer above the data link layer (e.g. the applications layer of the OSI model). The encoded packets (e.g. packets 805-809) are transported to base stations 103 and base station 105 through backbone network 107. In the embodiment, both base stations 103 and 105 transmit corresponding bursts of data packets over a radio channel, and wireless terminal 115 receives the bursts from a base station that is serving wireless terminal 115. (In some embodiments, a plurality of base stations may be serving wireless terminal 115 at a given time.) Wireless terminal 115 decodes the received packets with decoder 929 and presents the decoded packets to applications module 931.

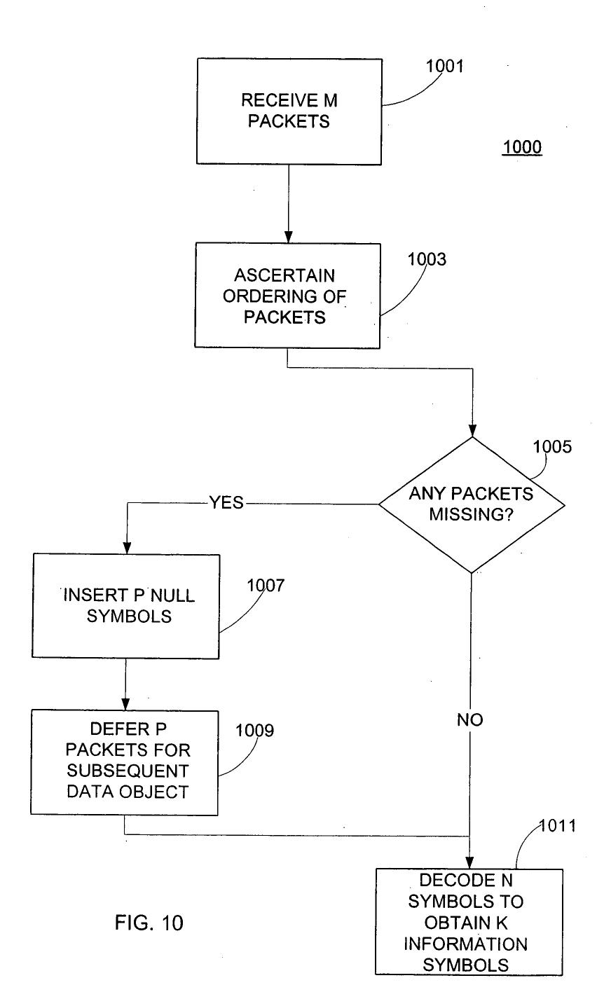

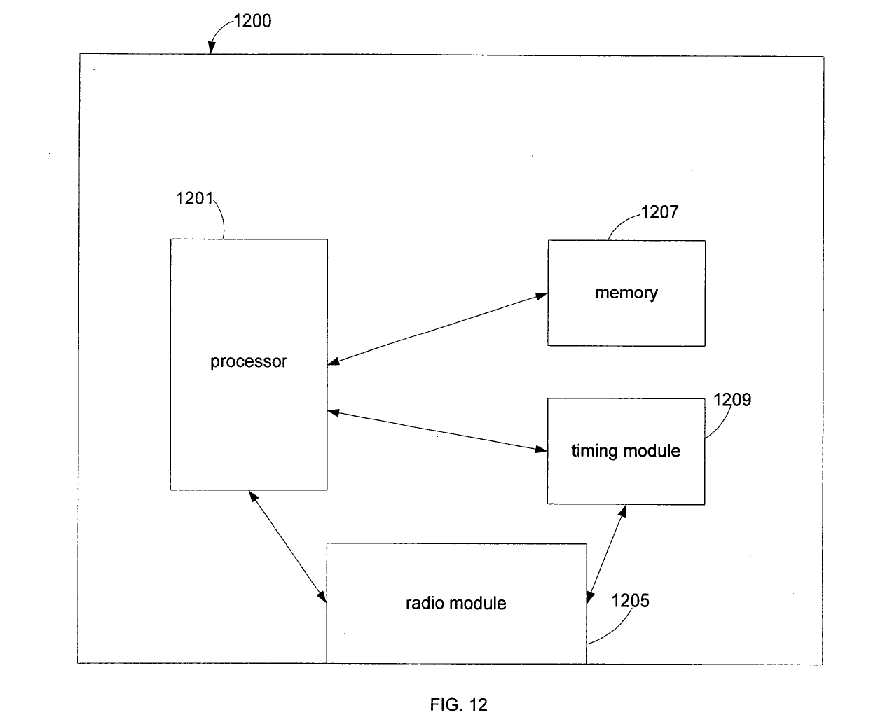

FIG. 10 shows a flow diagram 1000 for decoding a received data object (e.g. data object 801 as shown in FIG. 8) in accordance with an embodiment of the invention. In the embodiment, processor 1201 of wireless terminal 1200 (as shown in FIG. 12) executes software to perform logic corresponding to flow diagram 1000, although variations of the embodiment may utilize hardware, e.g. with discrete integrated circuits or with an application specific integrated circuit (ASIC).

In step 1001, wireless terminal 115 receives M packets that include N encoded symbols. In step 1003, wireless terminal 115 verifies the ordering of the received packets. Typically, packet numbers are inserted at the applications layer at service source 101, and wireless terminal orders the received packets in accordance with the inserted packet numbers in step 1003. In step 1005, wireless terminal 115 determines whether any packets are missing. In step 1007, wireless terminal 115 inserts null symbols (corresponding to erasures) indicating that the corresponding encoded symbols are missing so that wireless terminal 115 has N symbols to decode. In step 1009, if the received burst contains packets that are associated with a subsequent data object, the associated packets are stored for processing with the subsequent burst of data packets. In step 1011, wireless terminal 115 decodes the N in order to obtain K symbols that correspond to the data object.

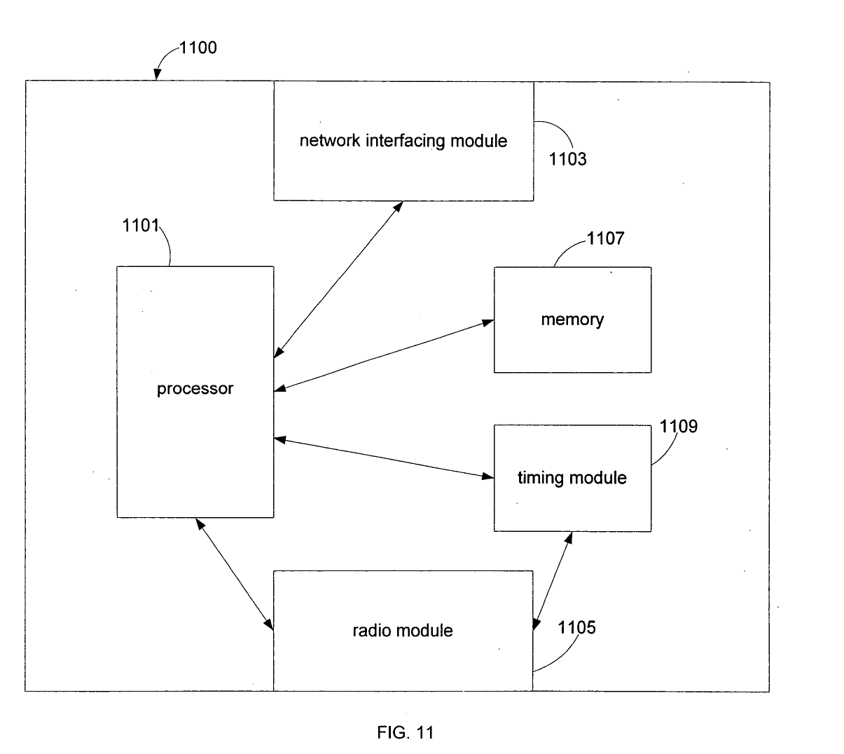

FIG. 11 shows an apparatus 1100 for a base station (e.g. base station 103) that supports time slice transmission according to an embodiment of the invention. Apparatus 1100 comprises a processor 1101, a network interfacing module 1103, a radio module 1105, a memory 1107, and a timing module 1109. Base station 1100 obtains data packets from backbone network 107 through network interfacing module 1103. The data packets are processed by processor 1101 and may be buffered in memory (data buffer) 1107 so that a group of data packets (which may be associated with one or more data services) can be formed for transmission in a burst of data packets to wireless terminal 115. Apparatus 1100 communicates with wireless terminal 115 over radio channel 111 through radio module 1105. Timing module 1109 determines an appropriate time for transmitting a burst over radio channel 111. In the embodiment, timing module 1109 has a crystal oscillator that is synchronized by the Global Positioning System (GPS) through a second radio channel that is supported by radio module 1105. Alternatively, timing module 1109 may be synchronized through network interfacing module 1103 and backbone network 107 by a centralized precision timing source. When timing module 1109 determines that a burst should be transmitted, timing module 1109 notifies processor 1101. Processor 1101 consequently obtains the group of data packets that are buffered in memory 1107 and transmits the group of data packets in the burst.

FIG. 12 shows an apparatus 1200 for wireless terminal 115 that supports time slice transmission according to an embodiment of the invention. Apparatus 1200 comprises a processor 1201, a radio module 1205, a memory 1207, and a timing module 1209. Timing module 1209 determines an appropriate time for receiving a burst of data packets. In the embodiment, timing module 1209 comprises a crystal oscillator and receives information in a preceding burst in which incremental time information is provided. Timing module 1209 uses the incremental timing information to determine the time for the next burst and notifies processor 1201. (In a variation of the embodiment, radio module 1205 may comprise a GPS receiver, providing time synchronization for timing module 1209.) Apparatus 1200 receives the burst of data packets, as was discussed in the context of FIG. 11, over radio channel 111 through radio module 1405. Processor 1201 processes the data packets and buffers them into memory (buffer storage) 1207 until the burst of data packets has been received. Processor 1201 processes the burst of data packets in accordance with the associated data service.

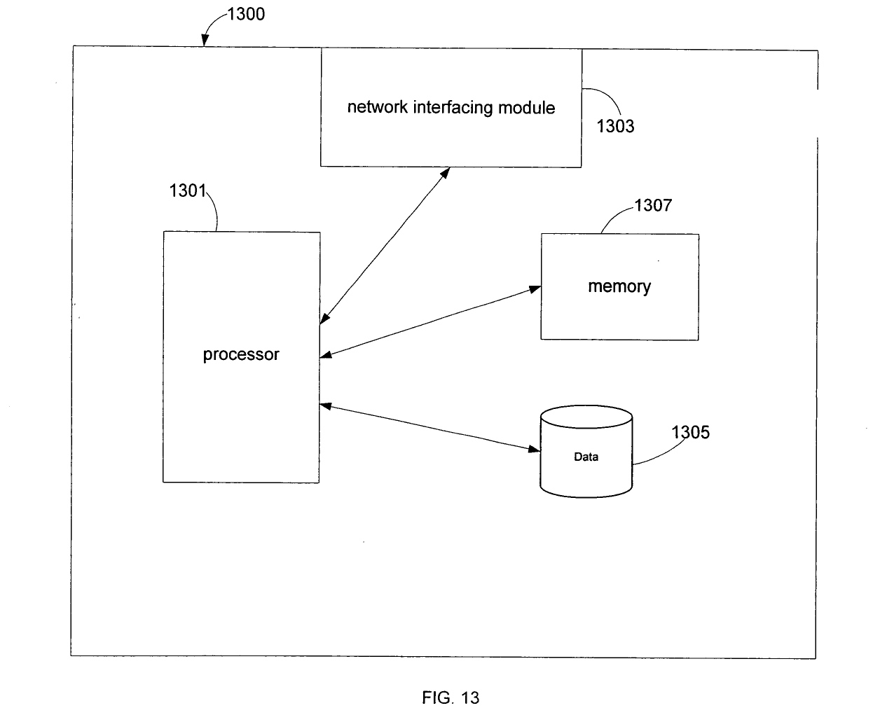

FIG. 13 shows apparatus 1300 for a service source that supports time slice transmission according to an embodiment of the invention. Apparatus 1300 comprises a processor 1301, a network interfacing module 1303, a data source 1305, and a memory 1307. Processor 1301 obtains data that supports a service from data source 1305. The embodiment supports different approaches for implementing data source 1305, including a database (that may be physically located at apparatus 1300 or may be external to apparatus 1300) and a video source (such as a video player or a video camera). Processor 1301 converts the data into information symbols that may be stored in memory 1307. By utilizing a forward error correcting (FEC) code (e.g. a Reed-Solomon code), processor 1301 encodes the data packets by obtaining N-K symbols from K information symbols that represent a data object, thus obtaining N encoded symbols. Processor 1301 converts the N encoded symbols into M packets that can be buffered into memory 1307 or may be sent directly to base stations (e.g. base station 103 and 105) through network interfacing module 1303 and multicast backbone network 107.

The selection of the FEC code may be fixed or may be dynamic. A dynamic selection may be determined by factors such as the associated service, delivery characteristics of backbone network 107, and wireless propagation characteristics of the wireless system. These factors may vary with time and with a location within wireless telecommunications system 900. An operator of a wireless system may consider the nature of the service, in which different services may tolerate different error levels. Some services may be very sensitive to errors such as a scheduled download. Other services such as a multicast streaming transmission may tolerate substantially more errors. Also, time skewing on backbone network 107 may vary so that the potential loss of packets during a handover may occur. Additionally, an operator of wireless system 900 may engineer wireless system 900 to have an expected error rate and a corresponding packet error rate. Such considerations may affect the selection of a forward error correction code. Typically, the greater the number of packet (and corresponding encoded symbols) that are lost or in error (corrupted), the greater the number of redundant symbols (corresponding to N-K symbols) that are required for a desired degree of data transmission robustness.

The operator may configure the FEC code by entering FEC code parameters (e.g. the type of code, code length, and the degree of redundancy) through a maintenance terminal (not shown) that has data connectivity with service source 101. The operator may configure associated FEC code parameters in accordance with the associated service, characteristics of backbone network 107, and radio propagation characteristics between wireless terminal 115 and the serving base station. Also, FEC code parameters may be specific to wireless system 900 if service source 101 serves a plurality of wireless systems and may further be specific to a subset of wireless system 900 (e.g. one or more base stations within the wireless system) if network and radio characteristics vary within wireless system 900.

If FEC code parameters are dynamic, wireless terminal 115 may be informed of FEC code parameters by transmitting the parameters to wireless terminal 115 over an overhead channel, which may be logically or physically distinct from the downlink channels that transports the bursts.

FIG. 14 shows a flow diagram for wireless terminal 115 for determining if a handover is required in accordance with an embodiment of the invention. After initialization of the wireless terminal 115, at step 1461, the wireless terminal 115 compiles a list of ‘L’ alternative center frequency values for one or more cells (e.g. cells 403 and 405 as shown in FIG. 4) adjacent to the cell (e.g. cell 401 in FIG. 4) that are providing the desired data service at step 1463. In the example provided, this list would include the broadcasting frequencies for cells 403 and 405. The alternative center frequency values may be provided in the bursts that are broadcast by the base station (e.g. base station 103) that is serving cell 401. For example, burst 209 may include a list of center frequency values of adjacent cells that provide the same data service. Additionally, information about the FEC code configuration may be included. (In the case that a data service is not provided in a neighboring cell, wireless terminal 115 may be instructed to continue being served by the cell that is providing the data service.)

Signal data are derived in the wireless terminal 115, at step 1465. These data include a received signal strength indicator (RSSI) value, a packet error rate (PER), and a bit-error rate (BER) value for the signal frequency, here designated as the original center frequency, used by the base station 103 in the wireless cell 401. A handover is considered or initiated if a pre-determined handover criterion has been met. In one embodiment, the handover criterion is met if the original frequency BER exceeds a predetermined quasi-error-free (QEF) limit or, alternatively, if the original frequency RSSI falls below a predefined value. If the handover criterion is not met, at decision block 1467, the wireless terminal 115 continues to monitor the original frequency RSSI and BER values for adverse change.

FIG. 15 shows a continuation of the flow diagram in FIG. 14. On the other hand, if the handover criterion has been met, wireless terminal 115 measures or determines the RSSI values for the ‘L’ adjacent cell transmission signals providing the same service, at step. 1569. The ‘L’ RSSI values for the adjacent cell transmission signals can be readings obtained after the handover criterion is met, or the RSSI values can be values which have been obtained and averaged over a selected period of time and retained in wireless terminal 115. Selection of a candidate signal frequency for handover is a function of the RSSI values obtained for the ‘L’ adjacent cell transmission signal frequencies.

The ‘N’ adjacent cell frequencies having the strongest RSSI values are designated as ‘N’ candidate frequencies, where N<=L. In the embodiment, 3<=N<=5. A list of (N+1) RSSI frequency values is formed including the ‘N’ candidate frequencies and the original frequency, at step 1571. In an alternative embodiment, the RSSI value for the original frequency is increased by a predetermined hysteresis value, for example 5 dB, to decrease the likelihood of frequent or unnecessary handovers from the original frequency to a candidate frequency, at optional step 1573. The candidate frequency having the greatest RSSI value is selected from the list, at step 1575, and the BER value is measured for this current candidate frequency, at step 1577.

If the current candidate frequency BER value exceeds the predetermined QEF limit at decision block 1579, the current candidate frequency is removed from the list at step 1581. If additional candidate frequencies remain in the list, at decision block 1583, the next candidate frequency value having the greatest RSSI value is designated as the current candidate frequency at step 1575, and the process proceeds to step 1577. If no candidate frequency values remain in the list at decision block 1583, wireless terminal 115 continues to use the original frequency in receiving information at step 1585, and operation continues to step 1463.

If the current candidate frequency BER value does not exceed the predetermined QEF limit at decision block 1579, the wireless terminal 115 executes a handover by switching to the current candidate frequency for receiving the next transmission burst at step 1587, and operation returns to step 1463 as above. In an embodiment, the QEF limit corresponds to a BER value of approximately 2×10⁻⁴ after Viterbi decoding in a digital video broadcasting receiver. As can be appreciated by one skilled in the art, an error-correction chain utilized in the digital video broadcasting receiver may include a Viterbi decoder stage and a Reed Solomon decoder stage. Accordingly, the BER value is approximately 2×10⁻⁴ after Viterbi decoding, corresponding to a BER value of approximately 10⁻¹² after Reed Solomon decoding.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. A method for processing data corresponding to a first service and received from a wireless system that includes a first base station and a second base station, the method comprising:
(a) receiving a first burst of data packets from the first base station, wherein the first burst corresponds to the first service;
(b) performing a handover from the first base station to the second base station;
(c) receiving a second burst of data packets from the second base station, wherein the second burst corresponds with the first service; and
(d) if an error is detected within the second burst, correcting the error in accordance with a first forward error correcting (FEC) code, wherein the error results from the handover.

2. The method of claim 1, wherein (d) comprises:
(i) determining whether a first data packet is missing from the second burst of data packets; and
(ii) calculating the first data packet from the second burst of data packets in accordance with the first FEC code.

3. The method of claim 1, wherein (d) comprises:
(i) determining whether a received symbol is incorrect, wherein the received symbol is contained in one of the data packets of the second burst; and
(ii) correcting the received symbol, wherein the received symbol is equal to a corresponding transmitted symbol.

4. The method of claim 3, wherein (d) further comprises:
(iii) if numbering of received data packets is not consecutive in the second burst, rearranging the received data packets so that the numbering is consecutive; and
(iv) if duplicate data packets are received within the second burst, discarding one of the duplicate data packets.

5. The method of claim 1, wherein (d) is performed at an application layer.

6. The method of claim 2, wherein (i) comprises:
(1) determining packet numbers that are associated with received packets of the second burst, wherein the packet numbers correspond to a transmitted packet ordering;
(2) if a packet number is missing from the received data packets, inserting a null symbol to signify an erasure within the second burst, wherein the null symbol is associated with a missing data packet.

7. The method of claim 1, wherein the first FEC code comprises a block forward error correcting (FEC) code.

8. The method of claim 1, wherein the first FEC code comprises an expandable forward error correcting code.

9. The method of claim 1, further comprising:
(e) receiving configuration information about the first FEC code.

10. The method of claim 9, wherein the configuration information is received over an overhead channel from one of a plurality of base stations that are associated with the wireless system.

11. The method of claim 1, further comprising:
(e) receiving a third burst of data packets from the first base station, wherein the third burst corresponds to a second service;
(f) performing a handover from the first base station to the second base station;
(g) receiving a fourth burst of data packets from the second base station, wherein the second burst corresponds to the second service; and
(h) if another error is detected within the fourth burst, correcting the other error by utilizing a second FEC code.

12. The method of claim 1, wherein (b) comprises:
(i) measuring a first signal characteristic of a first signal that is transmitted by the first base station;
(ii) measuring a second characteristic of a second signal that is transmitted by the second base station; and
(iii) if the first signal characteristic satisfies a first predefined criterion and if the second signal characteristic satisfies a second predefined criterion, switching reception from the first base station to the second base station.

13. The method of claim 1, wherein the first base station is associated with a first center frequency value and the second base station is associated with a second center frequency value.

14. The method of claim 1, wherein the first base station is associated with a first channelization code and the second base station is associated with a second channelization code.

15. The method of claim 1, wherein the first service is an Internet Protocol (IP) service.

16. A computer-readable medium having computer-executable instructions for performing the steps recited in claim 1.

17. A computer-readable medium having computer-executable instructions for performing the steps recited in claim 2.

18. A wireless terminal that receives data from a wireless system, the wireless system comprising a first base station and a second base station, comprising:
a storage buffer;
a timing module;
a radio module that communicates with the wireless system over a radio channel;
a processor that receives an indication from the timing module that one of a plurality of bursts of data packets is being transmitted and that stores said one of plurality of bursts into the storage buffer, the processor configured to perform:
(a) receiving a first burst of data packets from the first base station, wherein the first burst corresponds to an associated service;
(b) performing a handover from the first base station to the second base station;
(c) receiving a second burst of data packets from the second base station, wherein the second burst corresponds to the associated service; and
(d) if an error is detected within the second burst, correcting the error in accordance with a forward error correcting (FEC) code, wherein the error results from the handover.

19. The wireless terminal of claim 18, wherein the processor is configured to perform:
(i) determining whether a first data packet is missing from the second burst of data packets; and
(ii) calculating the first data packet from the second burst of data packets in accordance with the FEC code.

20. A service source that sends information to a wireless terminal through a wireless system, the wireless system comprising a first base station and a second base station, comprising:
a storage buffer;
a network interface; and
a processor, the processor configured to perform:
(a) obtaining the information from an information source, the information being associated with a service;
(b) forming a plurality of data packets from the information and storing the plurality of data packets into the storage buffer;
(c) determining a forward error correcting (FEC) code that provides a desired degree of robustness corresponding to the service and a possible loss of data packets when the wireless terminal handovers from the first base station to the second base station, wherein the first base station and the second base station transmit bursts of data packets;
(d) encoding the plurality of data packets in accordance with the forward error correcting (FEC) code; and
(e) retrieving the plurality of data packets from the storage buffer and sending the plurality of data packets to the wireless terminal through the network interface.

21. The service source of claim 20, wherein (c) comprises:
(i) receiving at least one parameter about the FEC code.

22. The service source of claim 20, wherein the FEC code is determined in accordance with a potential loss of data packets when a wireless terminal performs a handover.

23. The service source of claim 20, wherein the FEC code is selected in accordance with the service.

24. A method for processing data corresponding to a first service and received from a wireless system that includes a first base station and a second base station, the method comprising:
(a) receiving a first burst of data packets from the first base station, wherein the first burst corresponds to the associated service;
(b) performing a handover from the first base station to the second base station;
(c) receiving a second burst of data packets from the second base station, wherein the second burst corresponds to the associated service;
(d) determining packet numbers that are associated with received packets of the second burst, wherein the packet numbers correspond to a transmitted packet ordering;
(e) if a packet number is missing from the received data packets, inserting a null symbol to signify an erasure within the second burst, wherein the null symbol is associated with a missing data packet; and
(f) calculating the first data packet from the second burst of data packets in accordance with a forward error correcting (FEC) code.
